(19) United States
(12) Patent Application Publication
(10) Pub. No.: US 2025/0181846 A1
(43) Pub. Date: Jun. 5, 2025

(54) SESSION HANDLERS FOR ARTIFICIAL INTELLIGENCE COMMUNICATIONS

(71) Applicant: Rubrik, Inc., Palo Alto, CA (US)

(72) Inventors: Seungyeop Han, San Jose, CA (US); Alex Rand, San Francisco, CA (US); Steve Cheruiyot, Jersey City, NJ (US); Max Lin, Menlo Park, CA (US); Van Hoang Thuy Nguyen, Danville, CA (US); Yuchia Lin, San Francisco, CA (US)

(21) Appl. No.: 18/528,650

(22) Filed: Dec. 4, 2023

(51) Int. Cl. G06F 40/40; G06Q 30/01

(52) U.S. Cl. CPC G06F 40/40; G06Q 30/01

(57) ABSTRACT

Methods, systems, and devices for data management are described. A data management system (DMS) may support a communication service that may enable users to ask questions, troubleshoot problems, or initiate workflows. A user may initiate a communication session with the communication service by transmitting a query to the communication service. When a user initiates a chat session with the DMS, for example, via a query, the DMS may instantiate a handler of a handler class based on the use case (e.g., based on contextual information associated with the query). The DMS may use the handler to generate a use case specific prompt for a large language model (LLM) based on the query from the user. The DMS may provide the response from the LLM to the user. Different handler classes may also include use case specific function calls and parameters, which LLMs may use to trigger/initiate/suggest specific actions.

### FIELD OF TECHNOLOGY

The present disclosure relates generally to data management, including techniques for session handlers for artificial intelligence communications.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIGS. 1 and 2 illustrate examples of computing environments that support session handlers for artificial intelligence (AI) communications in accordance with aspects of the present disclosure.

FIG. 3 shows an example of a process flow that supports session handlers for AI communications in accordance with aspects of the present disclosure.

FIG. 4 shows a block diagram of an apparatus that supports session handlers for AI communications in accordance with aspects of the present disclosure.

FIG. 5 shows a block diagram of a data management system (DMS) that supports session handlers for AI communications in accordance with aspects of the present disclosure.

FIG. 6 shows a diagram of a system including a device that supports session handlers for AI communications in accordance with aspects of the present disclosure.

FIG. 7 shows a flowchart illustrating methods that support session handlers for AI communications in accordance with aspects of the present disclosure.

### DETAILED DESCRIPTION

A data management system (DMS) may support a communication service (such as a chatbot or interactive user platform) that may enable users to ask questions, troubleshoot problems, or initiate workflows. Such communication services may be applied for different use cases, such as malware detection, a general help desk, backup, or recovery. A user may initiate a communication session with the communication service by transmitting a query or other message to the communication service (for example, via a user interface (UI) provided by the DMS). In turn, the communication service may use a large language model (LLM) to process and/or respond to the query submitted by the user. The communication service may send the user's queries to the LLM in the form of a prompt. To improve the accuracy and/or relevance of responses generated by the LLM, the communication service may include contextual information (e.g., use case specific information or previous messages from the communication session) in the prompt. In some cases, however, the communication service may be unable to include all relevant context in the prompt, or the potential scope for the communications may be large, which may affect the quality of responses generated/predicted by the LLM. For example, if a number of tokens (e.g., words) in the prompt exceeds a token window size of the LLM (e.g., the maximum number of preceding tokens the LLM will consider), or the scope of the communications is overbroad, or both, the LLM may generate responses that are incomplete or contextually inaccurate.

Aspects of the present disclosure support techniques for providing different classes of handlers for different use cases and selecting a handler for a communication session with an LLM based on the use case or entry point of the communication session. Different handler classes may include use case specific information to include in LLM prompts. When a user initiates a chat session with the DMS, for example, via a query, the DMS may instantiate a handler of a handler class based on the use case. The use case may be indicated based on the text in the query (e.g., “malware” or “recovery”) or based on the entry point (e.g., the query being provided in response to a notification being sent to the user where the notification is associated with a certain use case or the query being provided via a particular widget, page, view or menu within the user interface for the DMS). The DMS may use the handler to generate a use case specific prompt for an LLM based on the query from the user. The DMS may provide the response from the LLM to the user. Different handler classes may also include use case specific function calls and parameters, which LLMs may use to trigger, initiate, or suggest specific actions. For example, if a prompt includes a request to perform a specific action (e.g., restore a database, create a live mount, adjust a cloud retention policy), the LLM may use a corresponding function call to initiate the requested action on the DMS.

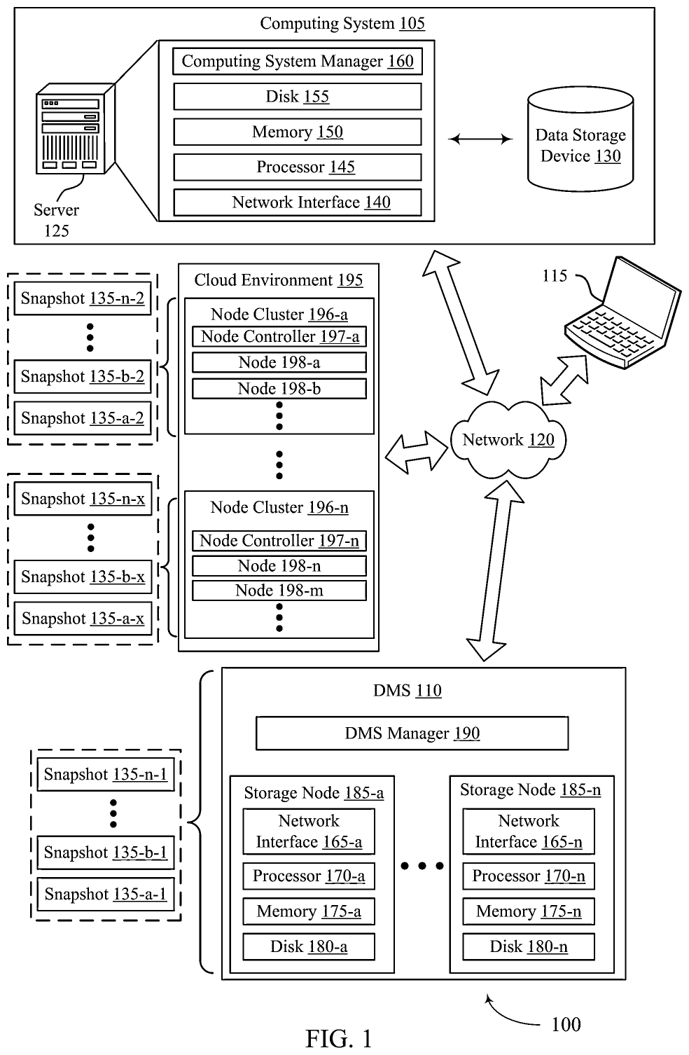

FIG. 1 illustrates an example of a computing environment 100 that supports session handlers for artificial intelligence (AI) communications in accordance with aspects of the present disclosure. The computing environment 100 may include a computing system 105, a DMS 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (Saas) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot 135 to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots 135, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots 135 associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster 196 across which data (e.g., data management data, metadata for data management data, etc.) for a customer or tenant is stored. Each node cluster 196 may include a node controller 197 which manages the nodes 198 of the node cluster 196. As an example, a node cluster 196 for one tenant or customer may be hosted on Microsoft Azure, and another node cluster 196 may be hosted on Amazon Web Services. In another example, multiple separate node clusters 196 for multiple different customers or tenants may be hosted on Microsoft Azure. Separating each customer or tenant's data into separate node clusters 196 provides fault isolation for the different customers or tenants and provides security by limiting access to data for each customer or tenant.

The control plane (e.g., the DMS 110, and specifically the DMS manager 190) manages tasks, such as storing backups or snapshots 135 or performing restorations, across the multiple node clusters 196. For example, as described herein, a node cluster 196-a may be associated with the first customer or tenant associated with the computing system 105. The DMS 110 may obtain (e.g., generate or receive) and transfer the snapshots 135 associated with the computing system 105 to the node cluster 196-a in accordance with a service level agreement for the first customer or tenant associated with the computing system 105. For example, a service level agreement may define backup and recovery parameters for a customer or tenant such as snapshot generation frequency, which computing objects to backup, where to store the snapshots 135 (e.g., which private data plane), and how long to retain snapshots 135. As described herein, the control plane may provide data management services for another computing system associated with another customer or tenant. For example, the control plane may generate and transfer snapshots 135 for another computing system associated with another customer or tenant to the node cluster 196-n in accordance with the service level agreement for the other customer or tenant.

To manage tasks, such as storing backups or snapshots 135 or performing restorations, across the multiple node clusters 196, the control plane (e.g., the DMS manager 190) may communicate with the node controllers 197 for the various node clusters via the network 120. For example, the control plane may exchange communications for backup and recovery tasks with the node controllers 197 in the form of transmission control protocol (TCP) packets via the network 120.

The DMS 110 may support a communication service (such as a chatbot or interactive user platform) that may enable users to ask questions, troubleshoot problems, or initiate workflows. A user may initiate a communication session with the communication service by transmitting a query or other message to the communication service (for example, via a UI provided by the DMS 110 displayed at a computing device 115). The communication service may use an LLM to process and/or respond to the message submitted by the user. For example, the LLM may be hosted in the cloud environment 195. The communication service may send the user's queries to the LLM in the form of a prompt.

To improve the accuracy and/or relevance of responses generated by the LLM, the communication service may include contextual information (e.g., use case specific information or previous messages from the communication session) in the prompt. The DMS 110 may include different classes of handlers for different use cases and may select a handler for a communication session with an LLM based on the use case or entry point of the communication session. Different handler classes may include use case specific information to include in LLM prompts. When a user initiates a chat session with the DMS 110, for example, via a query, the DMS 110 may instantiate a handler of a handler class based on the use case. The use case may be indicated based on the text in the query (e.g., “malware” or “recovery”) or based on the entry point (e.g., the query being provided in response to a notification being sent to the user where the notification is associated with a certain use case or the query being provided via a particular widget, page, view or menu within the user interface for the DMS). The DMS may use the handler to generate a use case specific prompt for an LLM based on the query from the user. The DMS 110 may provide the response from the LLM to the user (e.g., at a user interface of a computing device 115). Different handler classes may also include use case specific function calls and parameters, which LLMs may use to trigger/initiate specific actions. For example, if a prompt includes a request to perform a specific action (e.g., restore a snapshot 135, capture a snapshot of the computing system 105, adjust a retention policy for the node cluster 196), the LLM may use a corresponding function call to initiate the requested action on the DMS 110.

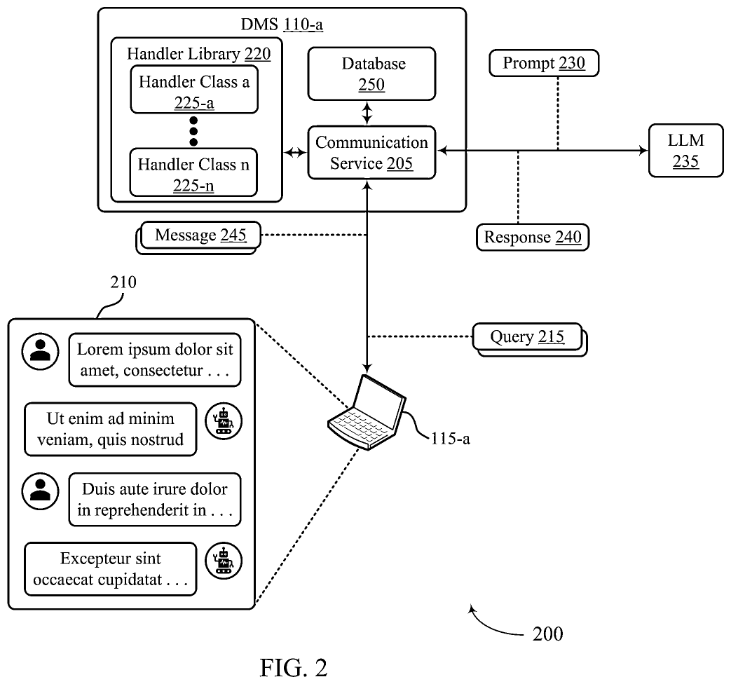

FIG. 2 shows an example of a computing environment 200 that supports session handlers for AI communications in accordance with aspects of the present disclosure. The computing environment 200 may implement one or more aspects of the computing environment 100. For example, the computing environment 200 includes a DMS 110-a and a computing device 115, which may be examples of a DMS 110 and a computing device 115 as described with reference to FIG. 1.

In the computing environment 200, a communication service 205 of the DMS 110-a may establish a communication session 210 with a user of the computing device 115-a (e.g., via a user interface of the computing device 115-a) and may use an LLM 235 to handle/process queries 215 received from the user. For example, the communication service 205 may generate a prompt 230 based on a query 215. The communication service 205 may transmit the prompt 230 to the LLM 235, which may return a response 240 to the prompt 230. The communication service 205 may provide a message 245 to the user (e.g., displayed on a user interface of the computing device 115-a as part of the communication session 210) based on the response 240. The communication service 205 may also be referred to as a communication manager or a chat manager.

LLMs 235 provide a new way for companies and organizations (such as the DMS 110) to interact with users. As described herein, an LLM 235 generally refers to a type of AI model that is designed to understand and generate human-like text based on patterns and information it learns from various data sources. These models may be trained on large datasets that contain a wide range of human language, such as books, articles, websites, and other written content. In some examples, the communication service 205 may communicate with the LLM 235 using Microsoft Copilot or other LLM-based services. LLMs 235 may be stateless. In other words, to get the LLMs 235 to retain/consider all relevant information/context, the communication service 205 may have to include all previous states and context as part of the prompt 230. For example, the DMS 110-a may include a database 250 which the communication service 205 may use to store previous queries 215, prompts 230, responses 240, and/or messages 245. For example, the database 250 may be a cloudSQL or VectorDB database.

To provide better user experience and lower operational costs, the communication service 205 may select and instantiate a handler of a handler class 225 from a set of multiple handlers (e.g., a first handler class 225-a through an nth handler class 225-n) supported by the DMS 110-a. The handler classes may be stored in a handler library 220 of the DMS 110-a. A handler of a particular handler class 225 may be used by the communication service 205 to include use case specific information in the prompts 230. A handler may also be referred to as a chat handler or a communication session handler.

For example, the DMS 110-a may include a first handler class associated with malware detection and/or handling, a second handler class associated with backup operations, a third handler class, a third handler class associated with restore operations, and a fourth handler class associated with a help desk (e.g., for frequently asked questions). Based on contextual information associated with an initial query 215 for a communication sessions 210, the DMS 110-a (e.g., the communication service 205) may select and instantiate a handler of a handler class 225 from the multiple handler classes 225. The communication service 205 may use the instantiated handler to generate a first prompt 230 based on the initial query 215. In some examples, the communication service 205 also may use the instantiated handler to generate additional prompts 230 based on subsequent queries 215 from the user.

The communication service 205 may store previous queries 215, prompts 230, responses 240, and/or messages 245 in the database 250. The queries 215, prompts 230, responses 240, and/or messages 245 may be encrypted prior to storage in the database 250 to protect any sensitive information. The communication service 205 may provide utilities such as application programming interfaces (APIs) for communication with the computing device 115-a (e.g., for communication of the queries 215 and the messages 245) and for communication with the LLM 235 (e.g., for communication of the prompts 230 and the responses 240).

Each handler class may include or may specify to the DMS 110-a static content which may be used by the LLM 235 to answer user queries 215. For example, a handler class 225 may identify (e.g., in the prompt 230) one or more information sources which the LLM may use to generate the response. In some examples, the prompt 230 may indicate that the LLM 235 is limited to use of the one or more information sources. For example, the information sources may be software documentation, user guides, or the like. For example, the handler classes may implement retrieval-augmented generation (RAG). For example, documents may be stored in a database (e.g., the database 250 or an external database) and may be retrieved by the handler. In some examples, the handler class 225 may include use case specific functions which may be called by the DMS 110-a based on a response 240 from the LLM 235. For example, the DMS 110-a may call functions such as backing up a particular computing object or restoring a snapshot. For example, a list of “function calls” (e.g., a list of functions that the DMS 110-a may call) may be included in the prompt 230 by the instantiated handler of the selected handler class 225, and the response 240 may indicate whether and which functions the DMS 110-a should call in response to the prompt along with correct variables for the given function.

In some examples, the communication service 205 may include one or more graphics in the messages 245. For example, the one or more graphics may be use-case-specific and may depend on the instantiated handler class 225. For example, application specific (e.g., use case specific) graphics may include charts or cards in addition to the text in the messages 245. For example, the charts or cards may be delivered as a parameter in the message 245.

In some examples, the communication service 205 may initiate a communication session 210 via calling an initialize chat function (e.g., InitChat), for example, in response to an initial query 215 or in response to sending a notification to a user of the computing device 115-a. The InitChat function may create a chat ID for the communication session 210. For example, the DMS 110-a may send a notification to a user based on detection of an event (e.g., time for backup, backup failure, node failure, or malware detected). The initial chat function may involve: receiving the initial query; selecting the handler class 225 and instantiating a handler of the selected handler class 225; generating the prompt 230 using the instantiated handler of the selected handler class 225, transmitting the prompt 230 to the LLM 235, receiving the response 240 from the LLM 235, and transmitting a message 245 to the computing device 115-a based on the response 240. After the initial chat function, the communication service 205 may continue the chat by calling a continue chat function (e.g., ContinueChat) which may: store prior queries 215, prompts 230, responses 240, and/or messages 245 (e.g., the chat history) in the database 250; receive additional queries 215; generate additional prompt 230 using the instantiated handler of the selected handler class 225 and/or the chat history in the database 250; transmit the additional prompts 230 to the LLM 235; receive additional responses 240 from the LLM 235; and transmit additional messages 245 to the computing device 115-a based on the additional responses 240 from the LLM 235. The ContinueChat function may use the Chat ID created by the InitChat function to find a corresponding chat, and chat history may be saved in the database with the corresponding Chat ID. Accordingly, the communication service 205 may manage communication with the LLM 235 (e.g., API calls to transmit the prompts 230 and receive the responses 240), communication with the computing device 115-a (e.g., formatting the messages 245, receiving the queries 215, and associated API calls), and storage and retrieval of the chat history in the database 250. As the communication service 205 may handle the chat initiation and the chat continuation functions, which may call the APIs to communicate with the computing device 115-a and the LLM 235, the different handler classes 225 may not implement the chat initiation and the chat continuation functions and instead may provide information to generate use-case specific prompts and/or use case specific function calls, thereby simplifying the generation of handler classes 225 for different use cases.

As the size of prompts 230 may be limited for the LLM 235, techniques may be used to handle prompt growth for subsequent prompts 230 as subsequent prompts may include chat history. For example, older queries 215, prompts 230, responses 240, and/or messages 245 in the chat history may be removed from subsequent prompts 230 before newer queries 215, prompts 230, responses 240, and/or messages 245 in the chat history (e.g., a first in first out scheme may be implemented to keep prompt size below a threshold). As another example, an error message may be provided to the computing device 115-a and displayed in the communication session 210 when the prompt size exceeds a limit, thereby indicating to a user of the computing device 115-a to initiate a new communication session 210.

As described herein, each handler class 225 may be associated with a different use cases and accordingly may include use case specific functions which may be included in the prompt 230 (e.g., a list of functions). In some examples, the list of functions may depend on the context (e.g., based on the specific query 215, the chat history, or other contextual information). The LLM 235 may determine whether the DMS 110-a should call the use case specific functions. In some examples, for example, if the function call proposed by LLM 235 changes the status of the system (e.g., creation of a new snapshot or a recovery procedure), the DMS 110-a may request confirmation from a user prior to performance of the function. For example, the message 245 may include a request for confirmation of the performance of a function from the user which may include information about the actions involved with the function (e.g., the effects of the function on the user's account or the user's data). Such request and confirmation may be referred to as a confirmation flow. In some examples, each function call may have a confirmation flow which may be included in the communication session 210 (e.g., as a message 245 and responsive query 215 from the computing device) whenever the LLM 235 indicates in a response 240 to call a function. In some examples, a function suggested by the LLM 235 may have a state PENDING_CONFIRMATION until authorization or confirmation is received from the user (e.g., via a query 215 from the computing device 115-a in the communication session 210). In some examples, the DMS 110-a may automatically (e.g., without user authorization) perform a function suggested by the LLM 235. In some examples, the DMS 110-a may inform the user (e.g., in a message 245) that the DMS 110-a will or intends to perform a function suggested by the LLM 235.

In some examples, where a function involves a confirmation flow, if the user indicates a confirmation (e.g., in a query 215), the DMS 110-a may set the function status to queued and may transmit a message 245 to the computing device 115-a (e.g., in the communication session 210) that the DMS 110-a will or intends to perform a function. The DMS 110-a may execute the function, which may involve calling an associated API. In some examples, if the function is synchronous, the DMS 110-a may update the status of the function to failed or succeeded as appropriate, and may transmit a message 245 to the computing device 115-a (e.g., in the communication session 210) indicating the result. In some examples, if the function is asynchronous, the DMS 110-a may identify the job ID of the function, for example, via a graphQL response for the function and may store the job ID in a table (e.g., in the database 250 or in local memory). The DMS 110-a may subsequently poll the status of the job based on the job ID (e.g., using a job request poller). In some examples, the function may be mapped to a REST API on cloud data management (CDM) to poll for the job. Any status change of the function identified by the polling may be updated in the table.

In some examples, chatbots such as the communication session 210 may be considered as a user interface (e.g., at the computing device). The DMS 110-a may perform actions (e.g., via graphQL API calls as described herein) and accordingly audit logs of the actions may be maintained (e.g., in the database 250). In some examples, when a function call is suggested by the LLM 235, an audit log may be added (e.g., to the database 250) that the function call is suggested by the LLM 235 which may be confirmed by the user. In some examples, the audit logs may be used to update the handler classes 225.

In some examples, the DMS 110-a may implement role based access control (RBAC) for the communication service. For example, in some cases, only administrators of customer accounts may be able to initiate communication sessions 210. As another example, the DMS 110-a may check on account privileges before authorizing a function call (e.g., RBAC may be performed for each function).

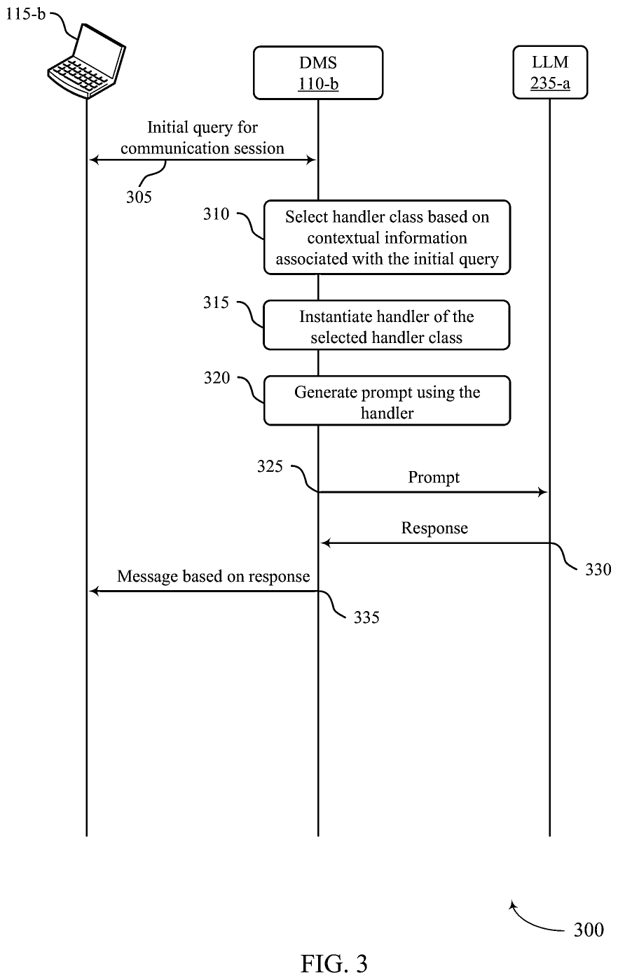

FIG. 3 shows an example of a process flow 300 that supports session handlers for AI communications in accordance with aspects of the present disclosure. The process flow 300 may implement one or more aspects of the computing environment 100 or the computing environment 200. For example, the process flow includes a DMS 110-b, a computing device 115-b, and an LLM 235-a, which may be examples of a DMS 110, a computing device 115, and an LLM 235 as described herein. In the following description of the process flow 300, operations between the computing device 115-b, the DMS 110-b, and the LLM 235-a may be added, omitted, or performed in a different order (with respect to the exemplary order shown).

At 305, the DMS 110-b may receive, from the computing device 115-b (e.g., via a user interface of the computing device 115-b), an initial query for a communication session with the LLM 235-a. For example, a communication service 205 of the DMS 110-b as described with reference to FIG. 2 may receive the initial query.

At 310, the DMS 110-b may select, based on contextual information associated with the initial query (e.g., an entry point for the initial query or other contextual information), a communication session handler class from a set of multiple communication session handler classes supported by the DMS. For example, a communication service 205 of the DMS 110-b as described with reference to FIG. 2 may select the communication session handler class.

In some examples, the DMS 110-b may transmit a notification to the computing device 115-b (e.g., for display on a user interface of the computing device 115-b). The contextual information used by the DMS 110-b to select the communication session handler class at 310 may be based on the notification. For example, the DMS 110-b may identify an event associated with a customer account associated with the user interface displayed at the computing device 115-b, and the notification is responsive to identification of the event. For example, the event may be a time for backup, a backup failure, a storage node failure, or a detection of malware.

In some examples, the DMS 110-b (e.g., a communication service 205 of the DMS 110-b as described with reference to FIG. 2) may identify one or more keywords in the initial query, and the contextual information may be based on the one or more keywords. For example, the keyword “backup” may indicate a use case of backup operations. As another example, the keyword “restore” may indicate a use case of restore operations. As another example, the keywords “malware,” or “ransomware” may indicate a use case of malware handling and resolution.

In some examples, the DMS 110-b may receive (e.g., a communication service 205 of the DMS 110-b as described with reference to FIG. 2 may receive), from the computing device 115-b (e.g., via a user interface of the computing device 115-b) a request for the communication session. The DMS 110-b may cause (e.g., the communication service 205 of the DMS 110-b as described with reference to FIG. 2 may cause), in response to the request, presentation of a set of multiple topics that correspond with respective communication sessions handler classes of the set of multiple communication session handler classes (e.g., backup operations, restore operations, malware handling, help desk). The DMS 110-b may receive (e.g., the communication service 205 of the DMS 110-b as described with reference to FIG. 2 may receive), from the computing device 115-b (e.g., via the user interface of the computing device 115-b), an indication of a selected topic of the set of multiple topics, and the selected communication session handler class may correspond to the selected topic.

In some examples, the set of multiple communication session handler classes may be associated with a respective set of multiple topics, and the respective set of multiple topics may include handling of malware, backup operations, restore operations, or a help desk.

At 315, the DMS 110-b may instantiate a communication session handler of the selected communication session handler class. For example, a communication service 205 of the DMS 110-b as described with reference to FIG. 2 may instantiate the communication session handler.

At 320, the DMS 110-b may generate, using the instantiated communication session handler, a prompt for the LLM 235-a based on the initial query. For example, a communication service 205 of the DMS 110-b as described with reference to FIG. 2 may generate the prompt.

In some examples, the prompt may include, based on the communication session handler, an indication of one or more information sources for the LLM 235-a to use to generate the response. For example, the information sources may be documents, databases, and/or web addresses.

At 325, the DMS 110-b may transmit the prompt to the LLM 235-a. For example, a communication service 205 of the DMS 110-b as described with reference to FIG. 2 may transmit the prompt.

At 330, the DMS 110-b may receive a response to the prompt from the LLM 235-a. For example, a communication service 205 of the DMS 110-b as described with reference to FIG. 2 may receive the response.

At 335, the DMS 110-b may transmit, to the computing device 115-b (e.g., for display on a user interface of the computing device 115-b), a message that is based on the response received from the LLM 235-a at 330. For example, a communication service 205 of the DMS 110-b as described with reference to FIG. 2 may transmit the message.

In some examples, the DMS 110-b may receive (e.g., the communication service 205 of the DMS 110-b as described with reference to FIG. 2 may receive), from the computing device 115-b (e.g., via a user interface of the computing device 115-b), a second query for the communication session. The DMS 110-b may generate (e.g., the communication service 205 of the DMS 110-b as described with reference to FIG. 2 may generate), using the communication session handler instantiated at 315, a second prompt for the LLM 235-a based on the second query, where the second prompt is based on the second query and further based on the initial query, the response previously received from the LLM 235-a, or both. The DMS 110-b may transmit (e.g., the communication service 205 of the DMS 110-b as described with reference to FIG. 2 may transmit) the second prompt to the LLM 235-a. The DMS 110-b may receive (e.g., the communication service 205 of the DMS 110-b as described with reference to FIG. 2 may receive) a second response to the second prompt from the LLM 235-a. The DMS 110-b may transmit (e.g., the communication service 205 of the DMS 110-b as described with reference to FIG. 2 may transmit), to the computing device 115-b (e.g., for display on a user interface of the computing device 115-b), a second message based on the second response received from the LLM 235-a. In some examples, the DMS 110-b may store (e.g., the communication service 205 of the DMS 110-b as described with reference to FIG. 2 may store) the initial query, the response previously received from the LLM, or both in a database associated with the DMS 110-b (e.g., the database 250 of FIG. 2). The second prompt may be based on the initial query, the response previously received from the LLM 235-a, or both, based on the storing the initial query, the response previously received from the LLM 235-a, or both in the database.

In some examples, the prompt may include one or more functions associated with the communication session handler class, the response at 330 may include an indication of whether to call the one or more functions, and the one or more function may cause the DMS 110-b to trigger one or more respective actions for a customer account associated with the user interface displayed at the computing device 115-b. In some examples, the response at 335 indicates for the DMS 110-b to call a function of the one or more functions, and the message at 335 includes an indication that the DMS 110-b intends to call the function. In some examples, the DMS 110-b may call the function based on the response at 330 indicating for the DMS 110-b to call the function. In some examples, the DMS 110-b may receive, from the computing device 115-b (e.g., via a user interface of the computing device 115-b), a command to perform the function in response to the message, and calling the function is based on the command. For example, the command may be received in a subsequent query of the communication session.

In some examples, the message at 335 may include data from the response at 330 (e.g., text in the response at 330).

In some examples, the DMS 110-b may include one or more graphics provided by the communication session handler in the message at 335. For example, charts, figures, or the formatting of the message at 335 may be based on the communication session handler.

In some examples, the DMS 110-b may identify a user account associated with a user interface of the computing device 115-b via which the initial query was received. The DMS 110-b may instantiate the communication session based on the user account being authorized by the DMS 110-b to communicate with the LLM 235-a. In some examples, if the user account is not authorized by the DMS 110-b to communicate with the LLM 235-a, the DMS 110-b may not instantiate a communication session (e.g., a chat session) and/or may transmit a message to the computing device 115-b for display on the user interface of the computing device 115-b that the user account is not authorized for a communication session.

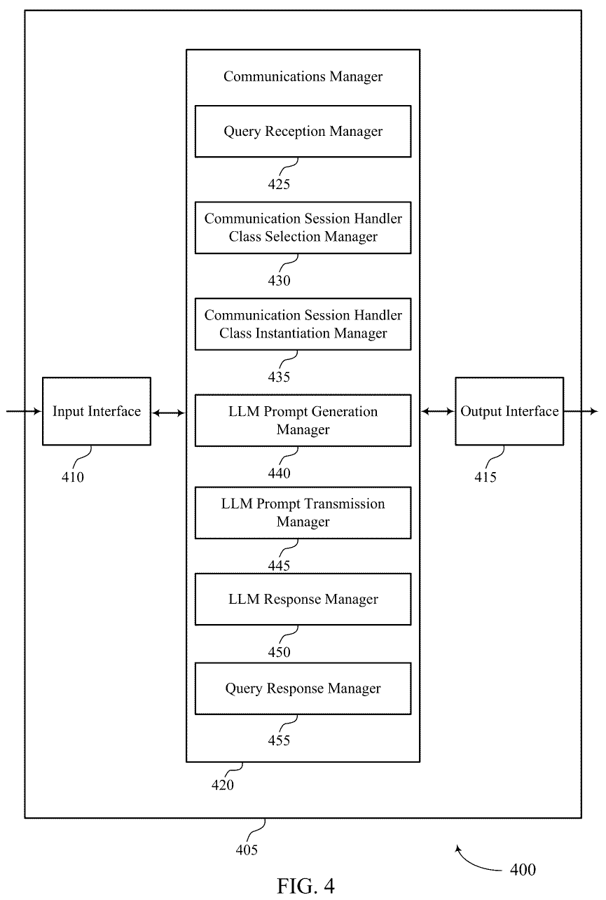

FIG. 4 shows a block diagram 400 of a system 405 that supports session handlers for AI communications in accordance with aspects of the present disclosure. In some examples, the system 405 may be an example of aspects of one or more components described with reference to FIG. 1, such as a DMS 110. The system 405 may include an input interface 410, an output interface 415, and a communications manager 420. The system 405 may also include one or more processors. Each of these components may be in communication with one another (e.g., via one or more buses, communications links, communications interfaces, or any combination thereof).

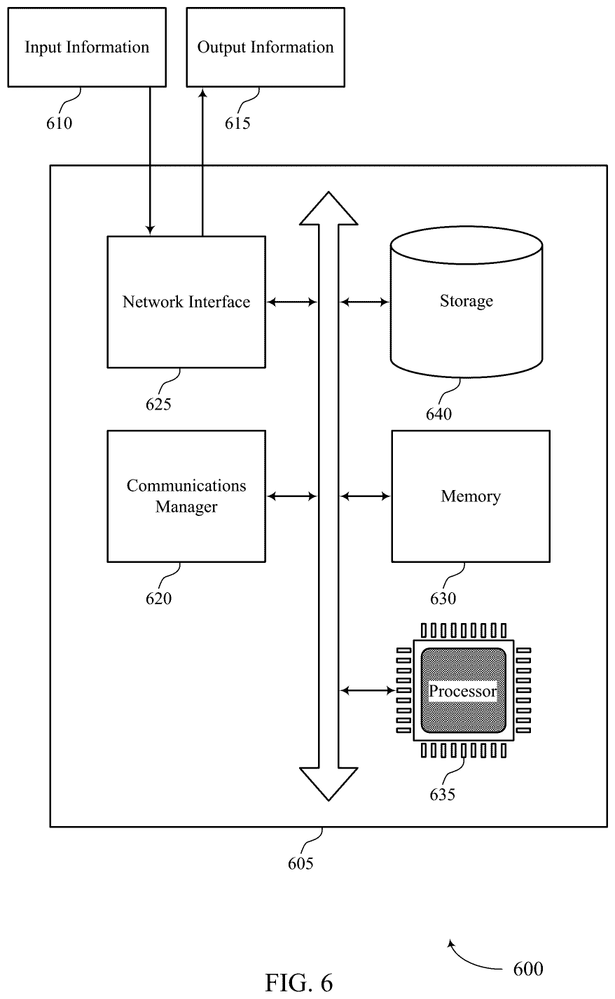

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the communications manager 420 to support session handlers for AI communications. In some cases, the input interface 410 may be a component of a network interface 625 as described with reference to FIG. 6.

The output interface 415 may manage output signaling for the system 405. For example, the output interface 415 may receive signaling from other components of the system 405, such as the communications manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the communications manager 420 may include a query reception manager 425, a communication session handler class selection manager 430, a communication session handler class instantiation manager 435, an LLM prompt generation manager 440, an LLM prompt transmission manager 445, an LLM response manager 450, a query response manager 455, or any combination thereof. In some examples, the communications manager 420, or various components thereof, may be configured to perform various operations (e.g., receiving, monitoring, transmitting) using or otherwise in cooperation with the input interface 410, the output interface 415, or both. For example, the communications manager 420 may receive information from the input interface 410, send information to the output interface 415, or be integrated in combination with the input interface 410, the output interface 415, or both to receive information, transmit information, or perform various other operations as described herein.

The query reception manager 425 may be configured as or otherwise support a means for receiving, by a DMS and via a user interface, an initial query for a communication session with an LLM. The communication session handler class selection manager 430 may be configured as or otherwise support a means for selecting, by the DMS and based on contextual information associated with the initial query, a communication session handler class from a set of multiple communication session handler classes supported by the DMS. The communication session handler class instantiation manager 435 may be configured as or otherwise support a means for instantiating, by the DMS, a communication session handler of the selected communication session handler class. The LLM prompt generation manager 440 may be configured as or otherwise support a means for generating, by the DMS using the communication session handler, a prompt for the LLM based on the initial query. The LLM prompt transmission manager 445 may be configured as or otherwise support a means for transmitting, by the DMS, the prompt to the LLM. The LLM response manager 450 may be configured as or otherwise support a means for receiving, from the LLM, a response to the prompt. The query response manager 455 may be configured as or otherwise support a means for transmitting, by the DMS to the user interface, a message that is based on the response received from the LLM.

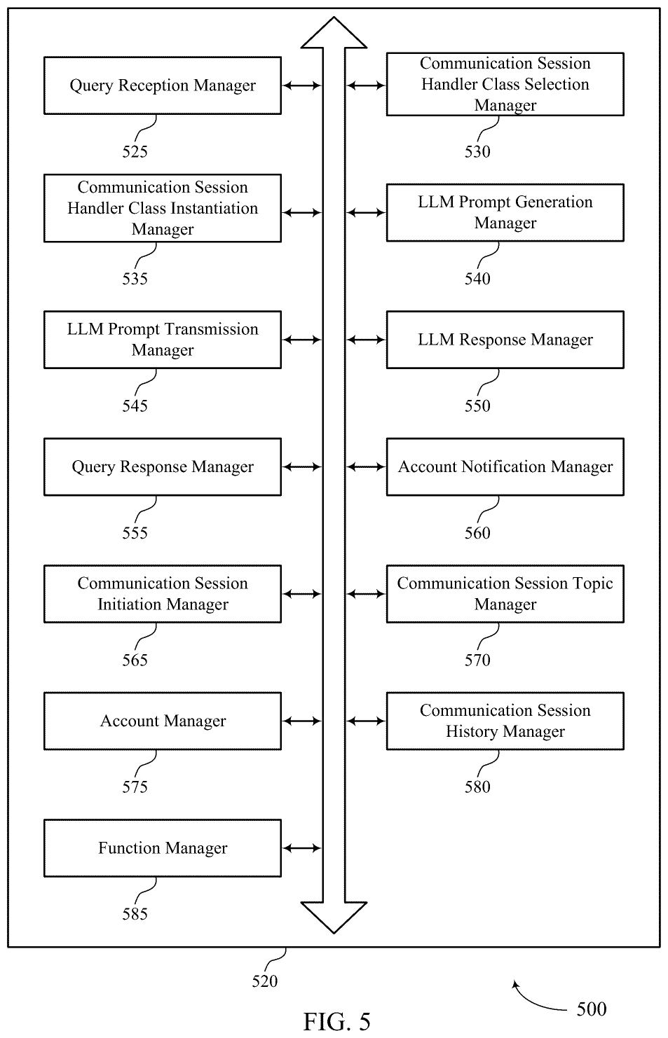

FIG. 5 shows a block diagram 500 of a communications manager 520 that supports session handlers for AI communications in accordance with aspects of the present disclosure. The communications manager 520 may be an example of aspects of a communications manager or a communications manager 420, or both, as described herein. The communications manager 520, or various components thereof, may be an example of means for performing various aspects of session handlers for AI communications as described herein. For example, the communications manager 520 may include a query reception manager 525, a communication session handler class selection manager 530, a communication session handler class instantiation manager 535, an LLM prompt generation manager 540, an LLM prompt transmission manager 545, an LLM response manager 550, a query response manager 555, an account notification manager 560, a communication session initiation manager 565, a communication session topic manager 570, an account manager 575, a communication session history manager 580, a function manager 585, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The query reception manager 525 may be configured as or otherwise support a means for receiving, by a DMS and via a user interface, an initial query for a communication session with an LLM. The communication session handler class selection manager 530 may be configured as or otherwise support a means for selecting, by the DMS and based on contextual information associated with the initial query, a communication session handler class from a set of multiple communication session handler classes supported by the DMS. The communication session handler class instantiation manager 535 may be configured as or otherwise support a means for instantiating, by the DMS, a communication session handler of the selected communication session handler class. The LLM prompt generation manager 540 may be configured as or otherwise support a means for generating, by the DMS using the communication session handler, a prompt for the LLM based on the initial query. The LLM prompt transmission manager 545 may be configured as or otherwise support a means for transmitting, by the DMS, the prompt to the LLM. The LLM response manager 550 may be configured as or otherwise support a means for receiving, from the LLM, a response to the prompt. The query response manager 555 may be configured as or otherwise support a means for transmitting, by the DMS to the user interface, a message that is based on the response received from the LLM.

In some examples, the account notification manager 560 may be configured as or otherwise support a means for transmitting, by the DMS to the user interface, a notification, where the initial query is responsive to the notification, and where the contextual information is based on the notification.

In some examples, the account notification manager 560 may be configured as or otherwise support a means for identifying an event associated with a customer account associated with the user interface, where the notification is responsive to identification of the event.

In some examples, the communication session handler class selection manager 530 may be configured as or otherwise support a means for identifying one or more keywords in the initial query, where the contextual information is based on the one or more keywords.

In some examples, the communication session initiation manager 565 may be configured as or otherwise support a means for receiving, by the DMS and via the user interface, a request for the communication session. In some examples, the communication session topic manager 570 may be configured as or otherwise support a means for causing, by the DMS and at the user interface in response to the request for the communication session, presentation of a set of multiple topics that correspond with respective communication sessions handler classes of the set of multiple communication session handler classes. In some examples, the communication session handler class selection manager 530 may be configured as or otherwise support a means for receiving, by the DMS and via the user interface, an indication of a selected topic of the set of multiple topics, where the selected communication session handler class corresponds to the selected topic.

In some examples, the query reception manager 525 may be configured as or otherwise support a means for receiving, by the DMS and via the user interface, a second query for the communication session. In some examples, the LLM prompt generation manager 540 may be configured as or otherwise support a means for generating by the DMS using the communication session handler, a second prompt for the LLM based on the second query, where the second prompt is based on the second query and further based on the initial query, the response previously received from the LLM, or both. In some examples, the LLM prompt transmission manager 545 may be configured as or otherwise support a means for transmitting, by the DMS, the second prompt to the LLM. In some examples, the LLM response manager 550 may be configured as or otherwise support a means for receiving, from the LLM, a second response to the second prompt. In some examples, the query response manager 555 may be configured as or otherwise support a means for transmitting, by the DMS to the user interface, a second message that is based on the second response received from the LLM.

In some examples, the communication session history manager 580 may be configured as or otherwise support a means for storing, by the DMS, the initial query, the response previously received from the LLM, or both in a database associated with the DMS, where the second prompt being based on the initial query, the response previously received from the LLM, or both is based on the storing in the database.

In some examples, the prompt includes one or more functions associated with the communication session handler class. In some examples, the response includes an indication of whether to call the one or more functions. In some examples, the one or more functions cause the DMS to trigger one or more respective actions for a customer account associated with the user interface.

In some examples, the response indicates for the DMS to call a function of the one or more functions. In some examples, the message includes an indication that the DMS intends to call the function.

In some examples, the function manager 585 may be configured as or otherwise support a means for, based on the response indicating for the DMS to call the function, calling the function by the DMS.

In some examples, the function manager 585 may be configured as or otherwise support a means for receiving, by the DMS and via the user interface, a command to perform the function in response to the message, where calling the function is based on the command.

In some examples, to support generating the prompt, the LLM prompt generation manager 540 may be configured as or otherwise support a means for including in the prompt, by the DMS using the communication session handler, an indication of one or more information sources for the LLM to use to generate the response.

In some examples, the message includes the response.

In some examples, the query response manager 555 may be configured as or otherwise support a means for including in the message, by the DMS, one or more graphics provided by the communication session handler.

In some examples, the account manager 575 may be configured as or otherwise support a means for identifying a user account associated with the user interface. In some examples, the communication session initiation manager 565 may be configured as or otherwise support a means for instantiating the communication session based on the user account being authorized by the DMS to communicate with the LLM.

In some examples, the set of multiple communication session handler classes are associated with a respective set of multiple topics. In some examples, the respective set of multiple topics include handling of malware, backup operations, restore operations, or a help desk.

FIG. 6 shows a block diagram 600 of a system 605 that supports session handlers for AI communications in accordance with aspects of the present disclosure. The system 605 may be an example of or include the components of a system 405 as described herein. The system 605 may include components for data management, including components such as a communications manager 620, an input information 610, an output information 615, a network interface 625, at least one memory 630, at least one processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610, output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting session handlers for AI communications). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640 may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

For example, the communications manager 620 may be configured as or otherwise support a means for receiving, by a DMS and via a user interface, an initial query for a communication session with an LLM. The communications manager 620 may be configured as or otherwise support a means for selecting, by the DMS and based on contextual information associated with the initial query, a communication session handler class from a set of multiple communication session handler classes supported by the DMS. The communications manager 620 may be configured as or otherwise support a means for instantiating, by the DMS, a communication session handler of the selected communication session handler class. The communications manager 620 may be configured as or otherwise support a means for generating, by the DMS using the communication session handler, a prompt for the LLM based on the initial query. The communications manager 620 may be configured as or otherwise support a means for transmitting, by the DMS, the prompt to the LLM. The communications manager 620 may be configured as or otherwise support a means for receiving, from the LLM, a response to the prompt. The communications manager 620 may be configured as or otherwise support a means for transmitting, by the DMS to the user interface, a message that is based on the response received from the LLM.

By including or configuring the communications manager 620 in accordance with examples as described herein, the system 605 may support techniques for session handlers for AI communications, which may provide one or more benefits such as, for example, improved reliability, improved user experience, more efficient utilization of computing resources, network resources or both, improved scalability, and/or improved security, among other possibilities.

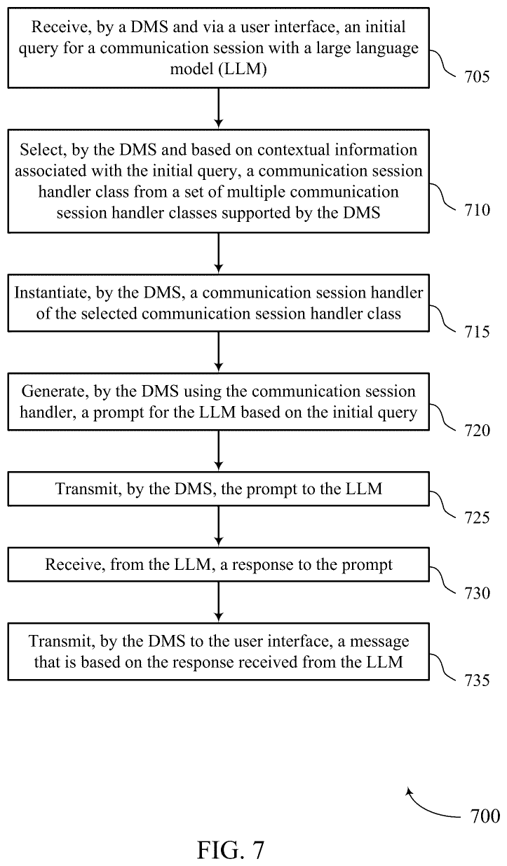

FIG. 7 shows a flowchart illustrating a method 700 that supports session handlers for AI communications in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the DMS to perform the described functions. Additionally, or alternatively, the DMS may perform aspects of the described functions using special-purpose hardware.

At 705, the method may include receiving, by a DMS and via a user interface, an initial query for a communication session with an LLM. The operations of block 705 may be performed in accordance with examples as disclosed herein. In some examples, aspects of the operations of 705 may be performed by a query reception manager 525 as described with reference to FIG. 5.

At 710, the method may include selecting, by the DMS and based on contextual information associated with the initial query, a communication session handler class from a set of multiple communication session handler classes supported by the DMS. The operations of block 710 may be performed in accordance with examples as disclosed herein. In some examples, aspects of the operations of 710 may be performed by a communication session handler class selection manager 530 as described with reference to FIG. 5.

At 715, the method may include instantiating, by the DMS, a communication session handler of the selected communication session handler class. The operations of block 715 may be performed in accordance with examples as disclosed herein. In some examples, aspects of the operations of 715 may be performed by a communication session handler class instantiation manager 535 as described with reference to FIG. 5.

At 720, the method may include generating, by the DMS using the communication session handler, a prompt for the LLM based on the initial query. The operations of block 720 may be performed in accordance with examples as disclosed herein. In some examples, aspects of the operations of 720 may be performed by an LLM prompt generation manager 540 as described with reference to FIG. 5.

At 725, the method may include transmitting, by the DMS, the prompt to the LLM. The operations of block 725 may be performed in accordance with examples as disclosed herein. In some examples, aspects of the operations of 725 may be performed by an LLM prompt transmission manager 545 as described with reference to FIG. 5.

At 730, the method may include receiving, from the LLM, a response to the prompt. The operations of block 730 may be performed in accordance with examples as disclosed herein. In some examples, aspects of the operations of 730 may be performed by an LLM response manager 550 as described with reference to FIG. 5.

At 735, the method may include transmitting, by the DMS to the user interface, a message that is based on the response received from the LLM. The operations of block 735 may be performed in accordance with examples as disclosed herein. In some examples, aspects of the operations of 735 may be performed by a query response manager 555 as described with reference to FIG. 5.

A method by an apparatus is described. The method may include receiving, by a DMS and via a user interface, an initial query for a communication session with an LLM, selecting, by the DMS and based on contextual information associated with the initial query, a communication session handler class from a set of multiple communication session handler classes supported by the DMS, instantiating, by the DMS, a communication session handler of the selected communication session handler class, generating, by the DMS using the communication session handler, a prompt for the LLM based on the initial query, transmitting, by the DMS, the prompt to the LLM, receiving, from the LLM, a response to the prompt, and transmitting, by the DMS to the user interface, a message that is based on the response received from the LLM.

An apparatus is described. The apparatus may include one or more memories storing processor executable code, and one or more processors coupled with the one or more memories. The one or more processors may individually or collectively operable to execute the code to cause the apparatus to receive, by a DMS and via a user interface, an initial query for a communication session with an LLM, select, by the DMS and based on contextual information associated with the initial query, a communication session handler class from a set of multiple communication session handler classes supported by the DMS, instantiate, by the DMS, a communication session handler of the selected communication session handler class, generate, by the DMS using the communication session handler, a prompt for the LLM based on the initial query, transmit, by the DMS, the prompt to the LLM, receive, from the LLM, a response to the prompt, and transmit, by the DMS to the user interface, a message that is based on the response received from the LLM.

Another apparatus is described. The apparatus may include means for receiving, by a DMS and via a user interface, an initial query for a communication session with an LLM, means for selecting, by the DMS and based on contextual information associated with the initial query, a communication session handler class from a set of multiple communication session handler classes supported by the DMS, means for instantiating, by the DMS, a communication session handler of the selected communication session handler class, means for generating, by the DMS using the communication session handler, a prompt for the LLM based on the initial query, means for transmitting, by the DMS, the prompt to the LLM, means for receiving, from the LLM, a response to the prompt, and means for transmitting, by the DMS to the user interface, a message that is based on the response received from the LLM.

A non-transitory computer-readable medium storing code is described. The code may include instructions executable by one or more processors to receive, by a DMS and via a user interface, an initial query for a communication session with an LLM, select, by the DMS and based on contextual information associated with the initial query, a communication session handler class from a set of multiple communication session handler classes supported by the DMS, instantiate, by the DMS, a communication session handler of the selected communication session handler class, generate, by the DMS using the communication session handler, a prompt for the LLM based on the initial query, transmit, by the DMS, the prompt to the LLM, receive, from the LLM, a response to the prompt, and transmit, by the DMS to the user interface, a message that is based on the response received from the LLM.

Some examples of the method, apparatus, and non-transitory computer-readable medium described herein may further include operations, features, means, or instructions for transmitting, by the DMS to the user interface, a notification, where the initial query may be responsive to the notification, and where the contextual information may be based on the notification.

Some examples of the method, apparatus, and non-transitory computer-readable medium described herein may further include operations, features, means, or instructions for identifying an event associated with a customer account associated with the user interface, where the notification may be responsive to identification of the event.

Some examples of the method, apparatus, and non-transitory computer-readable medium described herein may further include operations, features, means, or instructions for identifying one or more keywords in the initial query, where the contextual information may be based on the one or more keywords.

Some examples of the method, apparatus, and non-transitory computer-readable medium described herein may further include operations, features, means, or instructions for receiving, by the DMS and via the user interface, a request for the communication session, causing, by the DMS and at the user interface in response to the request for the communication session, presentation of a set of multiple topics that correspond with respective communication sessions handler classes of the set of multiple communication session handler classes, and receiving, by the DMS and via the user interface, an indication of a selected topic of the set of multiple topics, where the selected communication session handler class corresponds to the selected topic.

Some examples of the method, apparatus, and non-transitory computer-readable medium described herein may further include operations, features, means, or instructions for receiving, by the DMS and via the user interface, a second query for the communication session, generating by the DMS using the communication session handler, a second prompt for the LLM based on the second query, where the second prompt may be based on the second query and further based on the initial query, the response previously received from the LLM, or both, transmitting, by the DMS, the second prompt to the LLM, receiving, from the LLM, a second response to the second prompt, and transmitting, by the DMS to the user interface, a second message that may be based on the second response received from the LLM.

Some examples of the method, apparatus, and non-transitory computer-readable medium described herein may further include operations, features, means, or instructions for storing, by the DMS, the initial query, the response previously received from the LLM, or both in a database associated with the DMS, where the second prompt being based on the initial query, the response previously received from the LLM, or both may be based on the storing in the database.

In some examples of the method, apparatus, and non-transitory computer-readable medium described herein, the prompt includes one or more functions associated with the communication session handler class, the response includes an indication of whether to call the one or more functions, and the one or more functions cause the DMS to trigger one or more respective actions for a customer account associated with the user interface.

In some examples of the method, apparatus, and non-transitory computer-readable medium described herein, the response indicates for the DMS to call a function of the one or more functions and the message includes an indication that the DMS intends to call the function.

Some examples of the method, apparatus, and non-transitory computer-readable medium described herein may further include operations, features, means, or instructions for, based on the response indicating for the DMS to call the function, calling the function by the DMS.

Some examples of the method, apparatus, and non-transitory computer-readable medium described herein may further include operations, features, means, or instructions for receiving, by the DMS and via the user interface, a command to perform the function in response to the message, where calling the function may be based on the command.

In some examples of the method, apparatus, and non-transitory computer-readable medium described herein, generating the prompt may include operations, features, means, or instructions for including in the prompt, by the DMS using the communication session handler, an indication of one or more information sources for the LLM to use to generate the response.

In some examples of the method, apparatus, and non-transitory computer-readable medium described herein, the message includes the response.

Some examples of the method, apparatus, and non-transitory computer-readable medium described herein may further include operations, features, means, or instructions for including in the message, by the DMS, one or more graphics provided by the communication session handler.

Some examples of the method, apparatus, and non-transitory computer-readable medium described herein may further include operations, features, means, or instructions for identifying a user account associated with the user interface and instantiating the communication session based on the user account being authorized by the DMS to communicate with the LLM.

In some examples of the method, apparatus, and non-transitory computer-readable medium described herein, the set of multiple communication session handler classes may be associated with a respective set of multiple topics and the respective set of multiple topics include handling of malware, backup operations, restore operations, or a help desk.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, by a data management system (DMS) and via a user interface, an initial query for a communication session with a large language model (LLM);
selecting, by the DMS and based at least in part on contextual information associated with the initial query, a communication session handler class from a plurality of communication session handler classes supported by the DMS;
instantiating, by the DMS, a communication session handler of the selected communication session handler class;
generating, by the DMS using the communication session handler, a prompt for the LLM based at least in part on the initial query;
transmitting, by the DMS, the prompt to the LLM;
receiving, from the LLM, a response to the prompt; and
transmitting, by the DMS to the user interface, a message that is based at least in part on the response received from the LLM.

2. The method of claim 1, further comprising:
transmitting, by the DMS to the user interface, a notification, wherein the initial query is responsive to the notification, and wherein the contextual information is based at least in part on the notification.

3. The method of claim 2, further comprising:
identifying an event associated with a customer account associated with the user interface, wherein the notification is responsive to identification of the event.

4. The method of claim 1, further comprising:
identifying one or more keywords in the initial query, wherein the contextual information is based at least in part on the one or more keywords.

5. The method of claim 1, further comprising:
receiving, by the DMS and via the user interface, a request for the communication session;
causing, by the DMS and at the user interface in response to the request for the communication session, presentation of a plurality of topics that correspond with respective communication sessions handler classes of the plurality of communication session handler classes; and
receiving, by the DMS and via the user interface, an indication of a selected topic of the plurality of topics, wherein the selected communication session handler class corresponds to the selected topic.

6. The method of claim 1, further comprising:
receiving, by the DMS and via the user interface, a second query for the communication session;
generating by the DMS using the communication session handler, a second prompt for the LLM based at least in part on the second query, wherein the second prompt is based at least in part on the second query and further based at least in part on the initial query, the response previously received from the LLM, or both;
transmitting, by the DMS, the second prompt to the LLM;
receiving, from the LLM, a second response to the second prompt; and
transmitting, by the DMS to the user interface, a second message that is based at least in part on the second response received from the LLM.

7. The method of claim 6, further comprising:
storing, by the DMS, the initial query, the response previously received from the LLM, or both in a database associated with the DMS, wherein the second prompt being based at least in part on the initial query, the response previously received from the LLM, or both is based at least in part on the storing in the database.

8. The method of claim 1, wherein:
the prompt includes one or more functions associated with the communication session handler class,
the response includes an indication of whether to call the one or more functions, and
the one or more functions cause the DMS to trigger one or more respective actions for a customer account associated with the user interface.

9. The method of claim 8, wherein:
the response indicates for the DMS to call a function of the one or more functions; and
the message includes an indication that the DMS intends to call the function.

10. The method of claim 9, further comprising:
based at least in part on the response indicating for the DMS to call the function, calling the function by the DMS.

11. The method of claim 10, further comprising:
receiving, by the DMS and via the user interface, a command to perform the function in response to the message, wherein calling the function is based at least in part on the command.

12. The method of claim 1, wherein generating the prompt comprises:
including in the prompt, by the DMS using the communication session handler, an indication of one or more information sources for the LLM to use to generate the response.

13. The method of claim 1, wherein the message comprises the response.

14. The method of claim 1, further comprising:
including in the message, by the DMS, one or more graphics provided by the communication session handler.

15. The method of claim 1, further comprising:
identifying a user account associated with the user interface; and
instantiating the communication session based at least in part on the user account being authorized by the DMS to communicate with the LLM.

16. The method of claim 1, wherein:
the plurality of communication session handler classes are associated with a respective plurality of topics, and
the respective plurality of topics comprise handling of malware, backup operations, restore operations, or a help desk.

17. An apparatus, comprising:
one or more memories storing processor-executable code; and
one or more processors coupled with the one or more memories and individually or collectively operable to execute the code to cause the apparatus to:
receive, by a data management system (DMS) and via a user interface, an initial query for a communication session with a large language model (LLM);
select, by the DMS and based at least in part on contextual information associated with the initial query, a communication session handler class from a plurality of communication session handler classes supported by the DMS;
instantiate, by the DMS, a communication session handler of the selected communication session handler class;
generate, by the DMS using the communication session handler, a prompt for the LLM based at least in part on the initial query;
transmit, by the DMS, the prompt to the LLM;
receive, from the LLM, a response to the prompt; and
transmit, by the DMS to the user interface, a message that is based at least in part on the response received from the LLM.

18. The apparatus of claim 17, wherein the one or more processors are individually or collectively further operable to execute the code to cause the apparatus to:
transmit, by the DMS to the user interface, a notification, wherein the initial query is responsive to the notification, and wherein the contextual information is based at least in part on the notification.

19. The apparatus of claim 18, wherein the one or more processors are individually or collectively further operable to execute the code to cause the apparatus to:
identify an event associated with a customer account associated with the user interface, wherein the notification is responsive to identification of the event.

20. A non-transitory computer-readable medium storing code, the code comprising instructions executable by one or more processors to:
receive, by a data management system (DMS) and via a user interface, an initial query for a communication session with a large language model (LLM);
select, by the DMS and based at least in part on contextual information associated with the initial query, a communication session handler class from a plurality of communication session handler classes supported by the DMS;
instantiate, by the DMS, a communication session handler of the selected communication session handler class;
generate, by the DMS using the communication session handler, a prompt for the LLM based at least in part on the initial query;
transmit, by the DMS, the prompt to the LLM;
receive, from the LLM, a response to the prompt; and
transmit, by the DMS to the user interface, a message that is based at least in part on the response received from the LLM.
